(19) United States
(12) Patent Application Publication
(10) Pub. No.: US 2025/0251051 A1
(43) Pub. Date: Aug. 7, 2025

(54) PRESSURE DRIVEN FLUID DELIVERY SYSTEM

(71) Applicant: Zulu Pods, inc., Davie, FL (US)

(72) Inventors: Todd M. CURRIER, Sunderland, MA (US); Julius ROSENTHAL, Amherst, MA (US); Adam SMEDRESMAN, Norwalk, CT (US)

(21) Appl. No.: 19/095,959

(22) Filed: Mar. 31, 2025

Related U.S. Application Data
(63) Continuation of application No. 18/530,004, filed on Dec. 5, 2023, now Pat. No. 12,276,347.

(51) Int. Cl. F16K 17/16; F16K 17/194; F16K 17/196; F16K 17/30

(52) U.S. Cl. CPC F16K 17/16; F16K 17/194; F16K 17/196; F16K 17/30

(57) ABSTRACT

A fluid delivery system, comprising at least one source of pressurized fluid; and, a pod, comprising, an inlet in fluid communication with the source, a piston in fluid communication with the inlet, wherein pressure exerted on the piston by the pressurized fluid causes the piston to move into at least one reservoir, applying pressure to at least one reservoir fluid disposed therein, an outlet in fluid communication with the at least one reservoir for output of at least the at least one reservoir fluid being pressured out of the at least one reservoir by the piston, a pressurized fluid bypass tube in fluid communication with the inlet at one end and in fluid communication with the outlet at a second end, and, wherein the output at least one reservoir fluid and the bypassed pressurized fluid are combined to form a mixture to be applied at an area of application.

### RELATED APPLICATIONS

This application claims the benefit of priority under 35 U.S.C. § 120 of co-pending U.S. patent application Ser. No. 18/530,004 filed Dec. 5, 2023 and any of its priority applications, the contents of which are incorporated herein by reference in their entireties.

### FIELD OF THE INVENTION

The present invention, in some embodiments thereof, relates to fluid delivery and, more particularly, but not exclusively, to pressurized systems and methods for fluid delivery.

### BACKGROUND OF THE INVENTION

Various designs for fluid delivery systems exist. For example, U.S. Pat. No. 11,635,134, incorporated by reference herein, describes a packaged delivery apparatus for short term lubrication including a dispenser assembly, a flow control assembly, a pressure supply assembly and a releasing mechanism assembly.

Another example of a fluid delivery system is described in U.S. Pat. No. 9,624,798, incorporated by reference herein, which describes a lubrication system including an additive and a delivery system. During normal operational conditions, the lubricating oil circulating in the transmission system is collected and contained in a secondary oil reservoir to retain a quantity of the lubricating oil for use in an oil-out condition.

Another example of a fluid delivery system is described in U.S. Pat. No. 3,513,943, incorporated by reference herein, which describes encapsulated lubricants and their use and to packing material containing the same and to methods of making and using such packing material.

### SUMMARY OF THE INVENTION

According to an aspect of some embodiments of the present invention there is provided a pressure driven fluid delivery system, comprising: a source of pressurized fluid; and, a pod, comprising, an inlet in fluid communication with the source, a piston in fluid communication with the inlet, wherein pressure exerted on the piston by the pressurized fluid causes the piston to move into a reservoir, applying pressure to a reservoir fluid disposed therein, an outlet in fluid communication with the reservoir for output of at least the reservoir fluid being pressured out of the reservoir by the piston, a pressurized fluid bypass tube in fluid communication with the inlet at one end and in fluid communication with the outlet at a second end, and, wherein the output reservoir fluid and the bypassed pressurized fluid are combined to form a mixture to be applied at an area of application.

In an embodiment of the invention, the reservoir fluid and the bypassed pressurized fluid are combined in a mixture chamber located within the pod.

In an embodiment of the invention, the system further comprises at least one flow regulator or flow restrictor between the source of pressurized fluid and the inlet.

In an embodiment of the invention, the system further comprises at least one flow regulator or flow restrictor between the reservoir and the outlet.

In an embodiment of the invention, the system further comprises at least one check valve between the reservoir and the outlet.

In an embodiment of the invention, the system further comprises at least one flow regulator or flow restrictor between the source of pressurized fluid and the pressurized fluid bypass tube.

In an embodiment of the invention, the system further comprises a filter between the reservoir and the outlet.

In an embodiment of the invention, the system further comprises a fill valve in fluid communication with the reservoir.

In an embodiment of the invention, the fill valve is one-way.

In an embodiment of the invention, the piston is at least one of a membrane and a bellows.

In an embodiment of the invention, the pressurized fluid is compressor bleed air.

In an embodiment of the invention, the pressurized fluid is a liquid.

In an embodiment of the invention, a window is disposed in the inlet to provide fluid communication between the inlet and the fluid bypass tube.

In an embodiment of the invention, the reservoir fluid is at least one of a lubrication fluid, an anti-corrosion fluid, a protective fluid, a hydrating fluids, and a thermo-protective fluid.

In an embodiment of the invention, a portion of the pressurized fluid bypass tube is narrowed to create a Venturi effect at or near an outlet of the fluid reservoir to create a pulling effect on the piston.

According to an aspect of some embodiments of the present invention there is provided a method of using a pressure driven fluid delivery system, comprising: running a fluid compressor; inputting a pressurized fluid into a pod; applying at least a portion of the pressurized fluid to a piston, bellows or membrane to exert pressure on a reservoir fluid in a reservoir; outputting at least a portion of the reservoir fluid from the reservoir; bypassing at least a portion of the pressurized fluid from the inlet into a fluid bypass tube; mixing the output reservoir fluid and the bypassed pressurized fluid to create a mixture; applying the mixture to an area of application.

In an embodiment of the invention, the mixture is a mixture of air and liquid.

In an embodiment of the invention, the mixture forms a mist.

In an embodiment of the invention, the pressurized fluid is compressor bleed air.

In an embodiment of the invention, at least one of the input pressurized fluid and bypassed pressurized fluid is regulated by a regulator or restrictor.

In an embodiment of the invention, flow of the output reservoir fluid is controlled by at least one of a check valve, a flow regulator, a Venturi effect created by a narrowing in the bypass tube, and a flow restrictor.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example, are not necessarily to scale and are for purposes of illustrative discussion of embodiments of the invention. In this regard, the description taken with the drawings makes apparent to those skilled in the art how embodiments of the invention may be practiced.

In the drawings:

FIG. 1A is a block diagram of a pressure driven fluid delivery system, in accordance with an exemplary embodiment of the invention;

FIG. 1B is a block diagram of an alternative pressure driven fluid delivery system, in accordance with an exemplary embodiment of the invention;

FIG. 2A is a cross-sectional view of the pressure driven fluid delivery system of FIG. 1A, in accordance with an exemplary embodiment of the invention;

FIG. 2B is a cross-sectional view of the pressure driven fluid delivery system of FIG. 1B, in accordance with an exemplary embodiment of the invention;

FIG. 3A is a flowchart showing a method of using the pressure driven fluid delivery system of FIG. 1A, in accordance with an exemplary embodiment of the invention;

FIG. 3B is a flowchart showing a method of using the pressure driven fluid delivery system of FIG. 1B, in accordance with an exemplary embodiment of the invention;

FIG. 4A is a cross-sectional view of a pressure driven fluid delivery system with an integrated bypass tube, in accordance with an exemplary embodiment of the invention;

FIG. 4B is a cross-sectional view of a fluid pressure driven fluid delivery system with an integrated bypass tube, in accordance with an exemplary embodiment of the invention;

FIG. 5 is a schematic diagram showing a pressure driven fluid delivery system being used in conjunction with a simple jet engine, in accordance with an exemplary embodiment of the invention;

FIG. 6A is a cross-sectional view of a pressure driven fluid delivery system with a secondary reservoir, in accordance with an exemplary embodiment of the invention;

FIG. 6B is a cross-sectional view of an alternative pressure driven fluid delivery system with a secondary reservoir, in accordance with an exemplary embodiment of the invention; and,

FIG. 7 is a cross-sectional view of a bellows driven fluid delivery system, in accordance with an exemplary embodiment of the invention.

### DESCRIPTION OF SPECIFIC EMBODIMENTS OF THE INVENTION

The present invention, in some embodiments thereof, relates to fluid delivery and, more particularly, but not exclusively, to pressurized systems and methods for fluid delivery.

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

It should be understood that the fluid delivery systems described herein are used within larger systems, such as mechanical systems, to deliver fluids, such as lubrication fluids, anti-corrosion fluids, protective fluids, hydrating fluids, thermo-protective fluids and other fluids, to various components of the larger mechanical systems.

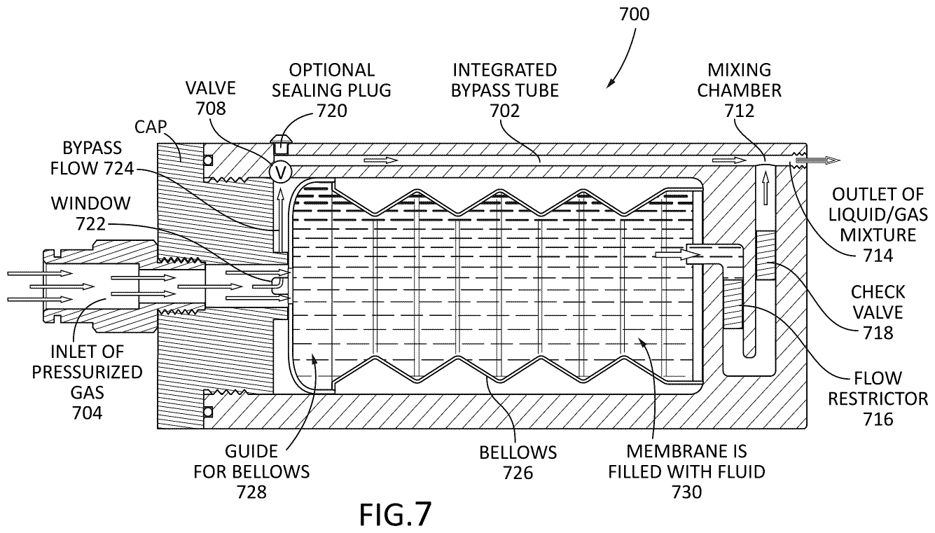

In some embodiments of the invention, a pressurized fluid or fluids are applied (e.g. input) to a fluid delivery system, such as a pod, to output a fluid and/or a liquid/air mixture from the fluid delivery system. In some embodiments of the invention, the fluid delivery system is piston driven, such as shown in many of the FIGS. herein. However, in some embodiments of the invention, a membrane, a bladder or a bellows is used to drive the fluid delivery system. An example of a bellows driven fluid delivery system is shown in FIG. 7 and described below.

It should be understood that “fluid” as used herein is a substance that has no fixed shape and yields easily to eternal pressure, such as gases and liquids. It should also be understood that in some embodiments described herein where a pressurized gas is used, the fluid used could instead, or additionally, be a liquid or gas/liquid combination in some embodiments, and vice versa. For example, in some embodiments a liquid is used to push a piston in the system whereas a gas is used to apply a reservoir fluid output of the system to its application area, in a gas/liquid mixture.

In some embodiments, an applied liquid such as a pressurized fuel is used to apply pressure to the piston of the piston driven fluid delivery system. In an embodiment where there is a bypass tube, mixture of the applied liquid and a liquid in a reservoir of the fluid delivery system could be mixed for output from the fluid delivery system. In some embodiments where there is no bypass tube, the applied liquid does not mix with the output of the fluid delivery system.

In some embodiments, compressed gas is used. In some embodiments, the compressed gas that is used is disposed of as an undesirable and/or unused byproduct of other system operations (e.g. compressed bleed air). That is, in some embodiments of the invention, instead of providing force to fluid delivery systems using dedicated compressed air or springs, the present inventions realize efficiency by using byproduct bleed air from other system components and processes. It should also be understood that the fluid delivery systems described herein can deliver these fluids one time or more than one time. Additionally, an interval of delivery for more than one time scenarios can be adjusted, as well as the duration of delivery, even from one delivery instance to the next. In some embodiments, fluid is delivered in response to information gathered by one or more sensors in the larger system and/or the fluid delivery system.

An exemplary application of using the bypass air is mixing it with the fluid output from the fluid assembly to create a mist, similar to an aerosol mist, which is then applied to at least one mechanical component, such as a gear or bearing.

In some embodiments, instead of using a pressurized liquid and/or gas a different or additional source of power is used to push a piston in the system. For example, a mechanical pressure-applying configuration could be used (e.g. motor with a gear or spring) or a pump (e.g. peristaltic pump) pulling ambient air to create the pressure could be used. It should be understood that while pressurized fluids are described herein as the mobilizing force to cause fluid delivery, the mobilizing force does not have to be a pressurized fluid. For example, in some embodiments of the invention, the bypass fluid is used in combination with a Venturi effect to create a pressure differential at or near enough a fluid reservoir outlet to drive the piston, where the piston is effectively pulled rather than pushed to cause fluid to be expelled from the fluid reservoir. In some embodiments, the Venturi effect is caused by a narrowing of the bypass tube. In some embodiments, the system includes at least one breather valve to assist with Venturi-based operation.

It should also be noted that the pressure driven nature of the described piston/membrane designs, in synergistic combination, render the fluid delivery systems insensitive to acceleration, maneuvering and/or orientation changes of the fluid delivery systems and/or the larger system.

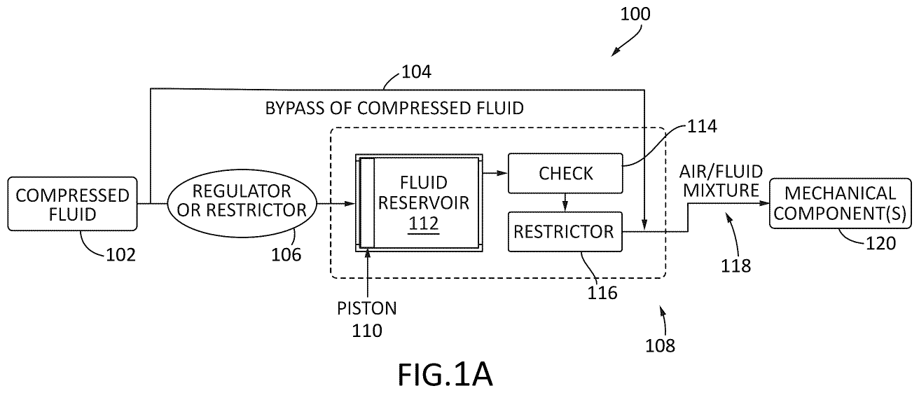

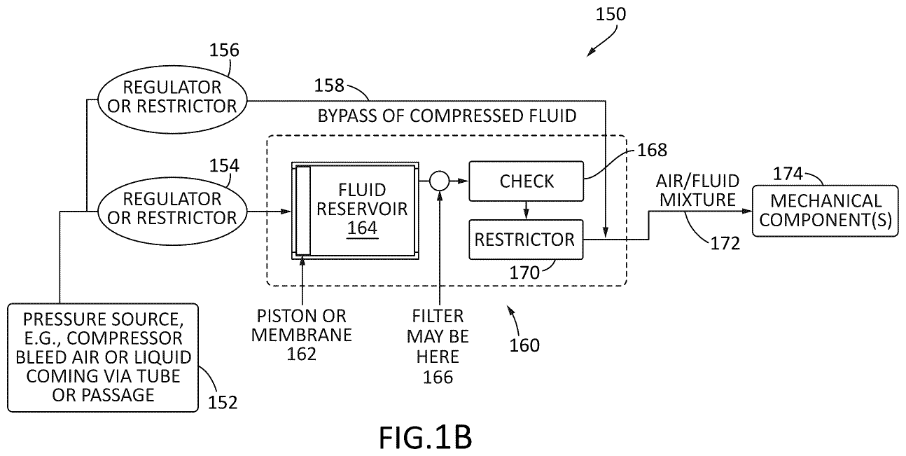

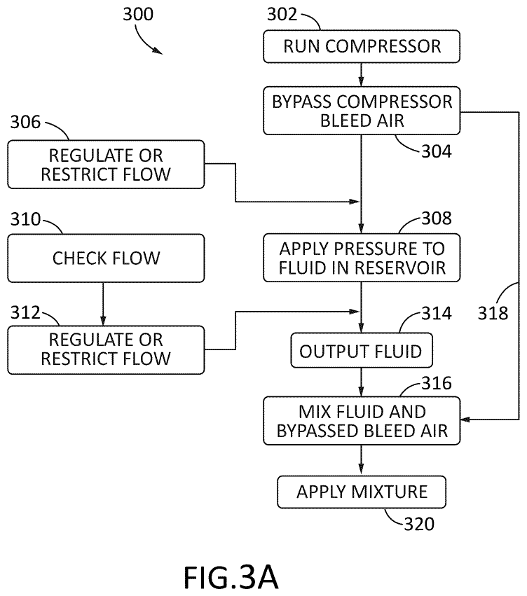

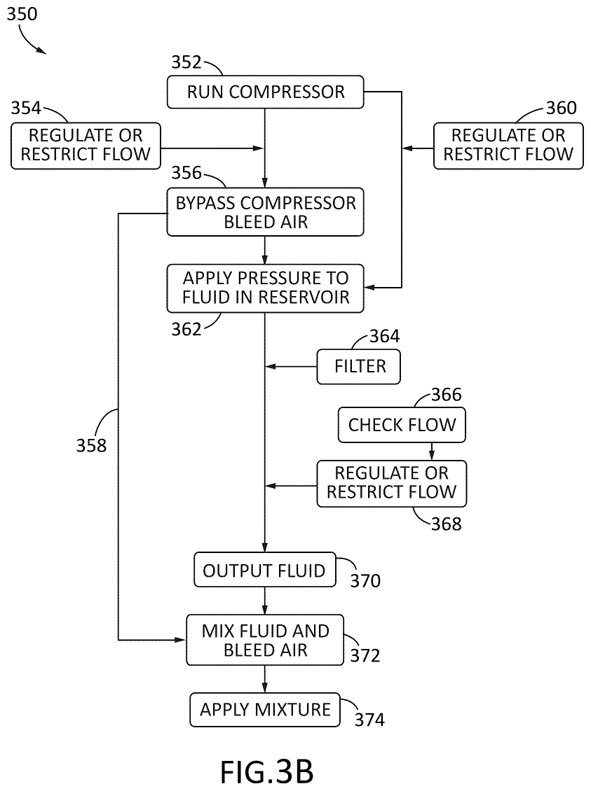

Referring now to the drawings, FIG. 1A is a block diagram of a fluid driven fluid delivery system 100, in accordance with an exemplary embodiment of the invention. For efficiency, the method 300 of use described in FIG. 3A will be described in conjunction with the description of the block diagram of an air driven fluid delivery system 100. In some embodiments of the invention, a source of pressurized air or gas 102, such as compressor bleed air from a compressor, possibly primarily being used for another purpose (302), is used to both: 1) apply pressure (308) to a fluid in a fluid reservoir 112 through a piston 110; and, 2) mix (316) with the fluid output (314) from the fluid assembly 108 to create a gas/liquid mixture 118 (e.g. two-phase gas/liquid) combining bypass air 104 from the pressurized air/gas source 102 with the fluid. Optionally, the gas/liquid mixture is in the form of an aerosol-like mist. In some embodiments of the invention, the gas/liquid mixture is thus applied (318) to at least one mechanical component or area of application 120 of the larger system. It should be noted that the compressed air or gas 102 is technically a fluid and the liquid within the reservoir 112 is also a fluid.

In some embodiments of the invention, the bleed air 102 is only used to apply pressure to the piston/membrane 110 and no bypass air 104 is used in the creation of a gas/liquid mixture 118, depending on the desired form and/or content and/or objective of fluid delivery and/or application.

In some embodiments of the invention, the input pressure of the driving fluid entering the system can be regulated. Pressure regulation will help ensure desired operational pressure within the fluid delivery system. In some embodiments of the invention, input pressure is controlled by a check valve that bleeds off excess pressure when it hits a predetermined value. In some embodiments, at least one flow regulator or flow restrictor 106 is disposed between the compressor bleed air 102 input into the system 100 by the compressor (not shown) and the piston 110, for regulating or restricting (306) bleed air flow into the fluid assembly 108 and/or for controlling how much bleed air is bypassed (304) around the fluid assembly 108 portion of the system 100.

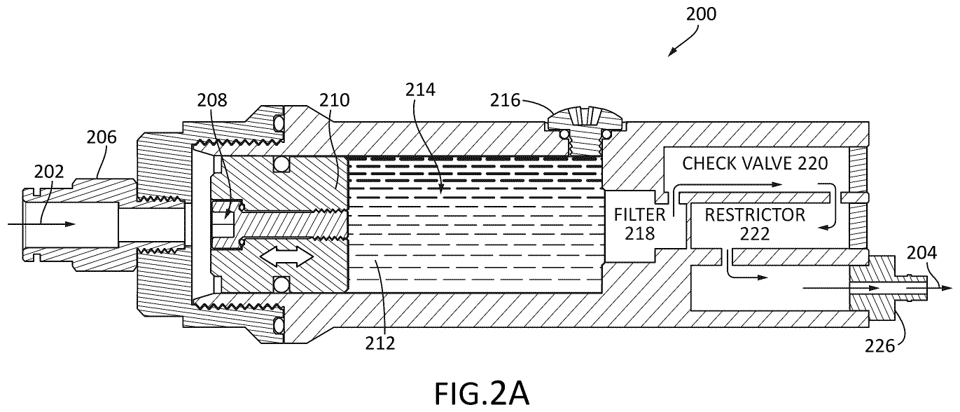

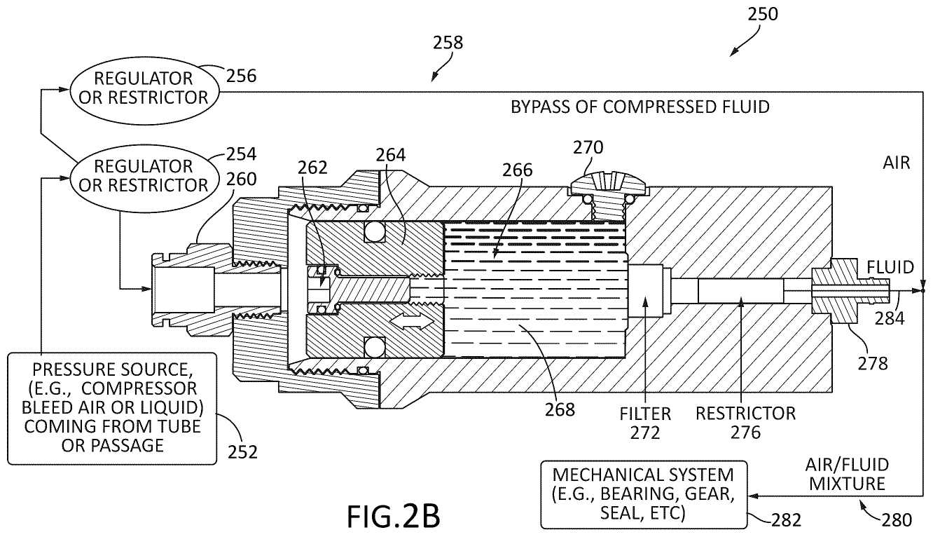

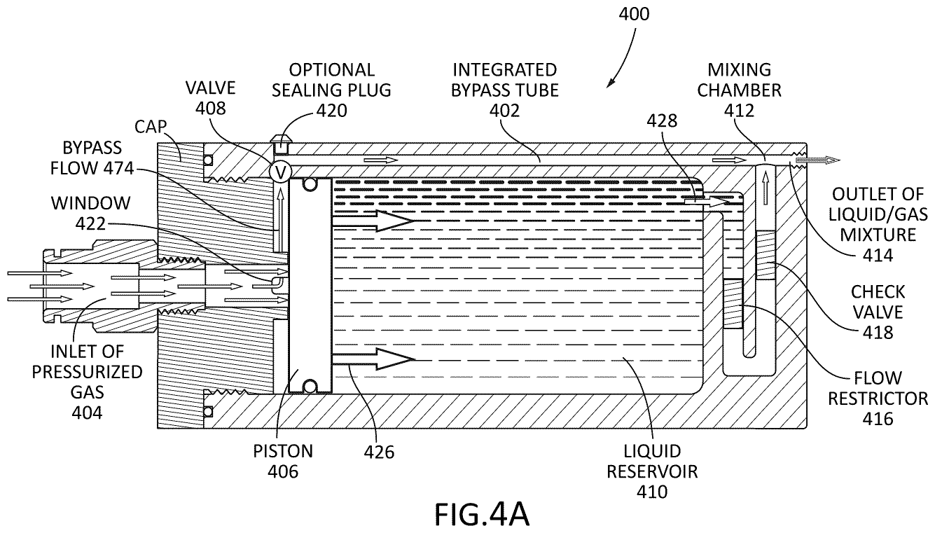

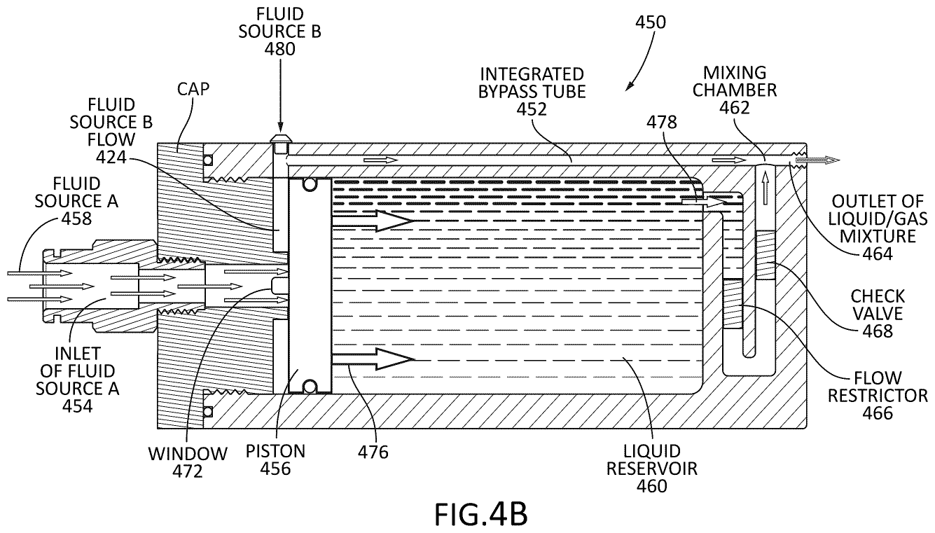

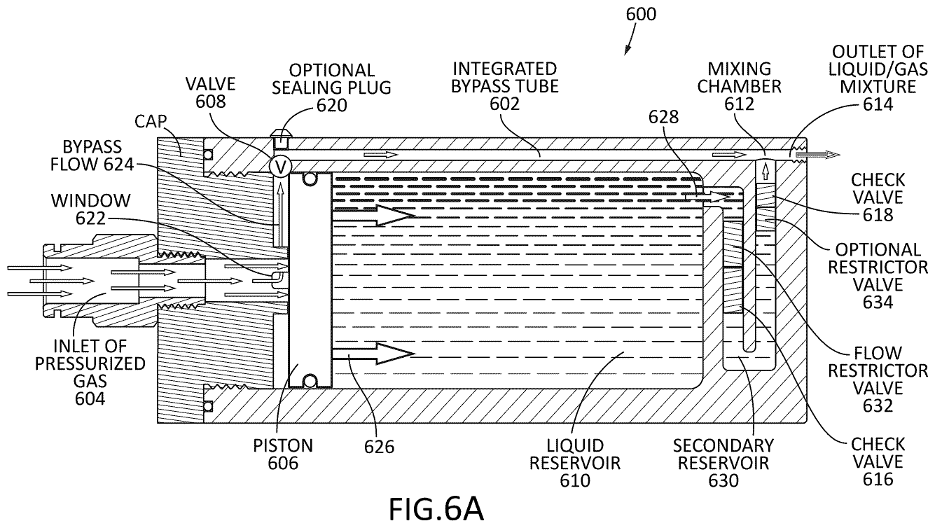

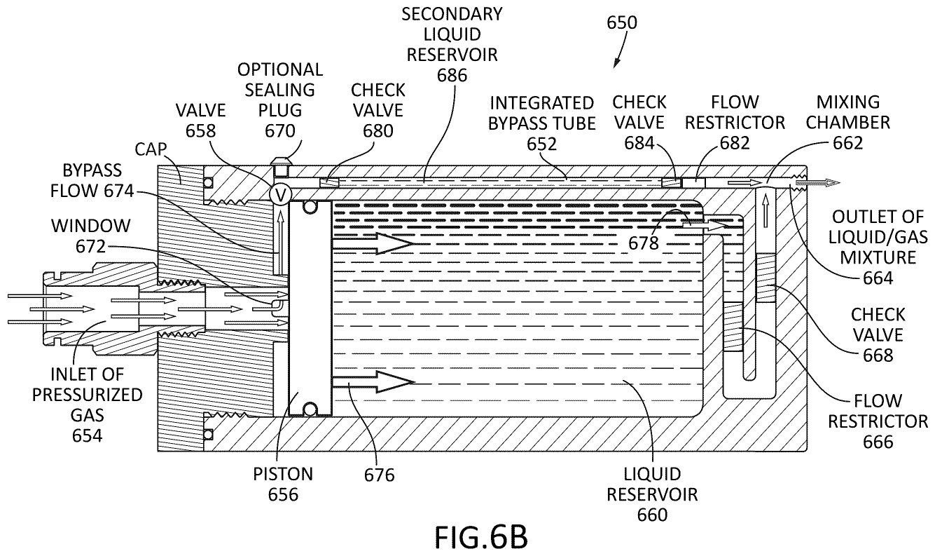

In an embodiment of the invention, the fluid assembly 108 comprises at least one check valve 114 and at least one flow regulator or flow restrictor 116 between the fluid reservoir 112 and an output nozzle (shown and described in more detail with respect to FIG. 2A) of the fluid delivery system 100. It should be understood that while the flow restrictor 116 is shown downstream of check valve 114 in FIG. 1A (and other FIGS.), the order could be reversed (such as shown in FIGS. 4A, 4B, 6A, 6B). The potential alternative configuration for a reversed check valve/restrictor order applies to any and all embodiments described herein.

In some embodiments of the invention, the check valve 114 is used to restrict backflow (310) of the fluid into the reservoir. In some embodiments, the check valve 114 also prevents fluid from leaking out of the fluid assembly 108 during atmospheric fluctuations that can add pressure to the fluid in the reservoir 112. In some embodiments of the invention, the flow regulator or flow restrictor 116 is used to control when and/or how much fluid is output (312), based on the pressure exerted by the piston 110 on the fluid in the fluid reservoir 112. For example, fluid is not output from the fluid assembly 108 below a predetermined pressure threshold and/or the volume of fluid output over time is regulated by the flow regulator.

In some embodiments of the invention, the system includes at least one rupture disc. Optionally, the rupture disc is between the fluid reservoir 112 and the restrictor 116.

In some embodiments of the invention, there is a valve for controlling gas/air flow between the compressor and the downstream components of the system 100. In some embodiments of the invention, the piston 110 is a membrane. In some embodiments of the invention, the flow regulator or flow restrictor 116 is upstream of the check valve 114, instead of downstream such as shown in FIG. 1A. It should also be understood that these components, and others described in system 100, are optionally placed in an inline configuration, partially inline or are in at least a partially winding configuration.

As described above, the liquid/gas mixture 118 is used, in some embodiments of the invention, to apply the fluid to at least one mechanical component 120, wherein the liquid/gas mixture has a desired or positive effect on the at least one mechanical component 120 and/or the larger mechanical system as a whole. For example, a lubricant fluid is applied to the at least one mechanical component in order to reduce friction between the mechanical component and something else, possibly another mechanical component (e.g. to reduce friction between two gears or reduce friction in a ball bearing). It should be understood that the desired or positive effect is varied based on the fluid delivered. Exemplary fluids delivered include lubrication fluids, anti-corrosion fluids, protective fluids, hydrating fluids, thermo-protective fluids and other useful fluids. Additionally, more than one type of fluid could be delivered to the at least one mechanical component, by mixing two different fluids in the same reservoir 112 or by using two separate fluid assemblies 108 or fluids delivery systems 100 loaded with different fluids but directed towards the same mechanical component(s).

FIG. 1B is a block diagram of an alternative pressure driven fluid delivery system 150, in accordance with an exemplary embodiment of the invention. For the sake of brevity, certain commonalities or like functionality with the fluid delivery system 100 will not be repeated, but it should be understood that fluid delivery system 150 does share substantial operational and/or structural concepts and features described in the context of FIGS. 1A and 2A could apply to the devices depicted in FIGS. 1B and 2B. For example, source bleed air 152 from a compressor (352) being used for a primary purpose, different from its use described herein, is used to provide functionality to the fluid delivery system 150. In some embodiments of the invention, bleed air 158 which is bypassed (356) around a fluid assembly 160 passes (354) through a flow regulator or a flow restrictor 156 as it moves towards mixing into a mist 172 with the fluid output (370) by the fluid assembly 160.

Additionally, the method 350 of use described in FIG. 3B will be described in conjunction with the description of the block diagram of an air driven fluid delivery system 150.

In some embodiments of the invention, some of the bleed air is used to apply (362) pressure to a piston or membrane 162. Optionally, this portion of the bleed air is passed (360) through a flow regulator or flow restrictor 154. Movement of the piston 162 applies (362) pressure on a fluid in a fluid reservoir 164. The fluid which is output (370) from the fluid reservoir 112 is mixed (372) with the bypass bleed air 158 and is then output from the fluid assembly 160 as a mist 172. In some embodiments of the invention, the mixing happens within a mix chamber in the fluid assembly 160 and additionally and/or alternatively, the mixing happens in an external fitting, such as a T- or Y-fitting. The mist 172 is then applied (374) to at least one mechanical component or area of application 174, in an embodiment of the invention.

In some embodiments, at least one filter 166 for filtering (364), check valve 168 for preventing (364) backflow and/or flow regulator or flow restrictor 170 for regulating or restricting (368) flow is placed downstream of the fluid reservoir 164, and in any order. It should also be understood that these components, and others described in system 100, are optionally placed in an inline configuration, partially inline or are in at least a partially winding configuration

FIG. 2A is a cross-sectional view of an exemplary fluid delivery system 200 of the block diagram pressure driven fluid delivery system 100 of FIG. 1A. Compressor bleed air is input 202 into the system 200 at an air fitting 206, in an embodiment of the invention. In some embodiments, the bleed air flows into a pressure chamber 208 to exert pressure on a piston 210. The piston 210 moves towards an output nozzle 226, pushing fluid 212 in a fluid reservoir 214 downstream, also towards the output nozzle 226.

In some embodiments of the invention, at least one filter 218, check valve 220 and/or flow regulator or flow restrictor 222 is placed downstream of the fluid reservoir 214, and in any order. In some embodiments of the invention, the mixing happens within a mix chamber and additionally and/or alternatively, the mixing happens in an external fitting, such as a T- or Y-fitting, located downstream of the nozzle 226. The air/fluid mixture, sometimes in the form of a mist, thus generated is then applied to at least one mechanical component, in an embodiment of the invention.

In some embodiments of the invention, at least one fluid (i.e. there can be a mix of fluids in the reservoir 214) is applied to the fluid delivery system 200 through a single direction fill port 216 (optionally it has a seal or valve). In some embodiments of the invention, there is a fill port oriented in a direction that is not aligned with the minor axis of the system 100. In some embodiments of the invention, there is a filter upstream and/or downstream of the fill valve 216.

FIG. 2B is a cross-sectional view of an exemplary fluid delivery system 250 of the block diagram air driven fluid delivery system 150 of FIG. 1B, in accordance with an exemplary embodiment of the invention. Compressed bleed air 252, for example from a compressor, is input into a flow regulator or flow restrictor 254, in some embodiments of the invention, and then split into a bypass path 258 and the input air fitting 260 and/or pressure chamber 262 for operation of the piston/membrane 264. Piston 264 movement towards an output nozzle 278 effectuates movement of a fluid 268 in a fluid reservoir 266 downstream and towards the output nozzle 278.

In an embodiment of the invention, the bypass bleed air 258 is mixed with the output fluid 284 to create a gas/liquid mixture 280, for example in a mist-like form. The mixture 280 is then applied to at least one mechanical component 282.

In some embodiments, at least one filter 272, check valve 274 and/or flow regulator or flow restrictor 276 is placed downstream of the fluid reservoir 266, and in any order. Further, one or both of the flow restrictors 254, 256 are not used and/or are optional.

In some embodiments of the invention, at least one fluid (i.e. there can be a mix of fluids in the reservoir 266) is applied to the fluid delivery system 250 through a single direction fill valve 270 (it has a seal). In some embodiments of the invention, there is a filter upstream and/or downstream of the fill valve 270.

FIG. 4A is a cross-sectional view of a pressure driven fluid delivery system 400 with an integrated bypass tube 402, in accordance with an exemplary embodiment of the invention. In system 400, pressurized gas/air enters through an inlet 404 to at least one of: a) exert pressure against a piston 406; and b) enter the integrated bypass tube 402. In some embodiments of the invention, a window 422 is provided to the inlet 404 to allow at least some flow 424 of pressurized gas to be diverted from the piston 406 to bypass exerting pressure on the piston 406 and instead flow around towards the integrated bypass tube 402. In an embodiment of the invention, bypass flow into the tube 402 is controlled by valve 408.

Pressure exerted on the piston 406 by the pressurized gas causes the piston 406 to move 426, expelling liquid in a liquid reservoir 410 downstream 428 towards a mixing chamber 412, where the liquid from the reservoir 410 is optionally mixed with the gas/air which is introduced into the chamber 412 from the bypass tube 402. The liquid/gas mixture is then output from the system 400 at an outlet 414, in some embodiments of the invention. In some embodiments, a nozzle (not shown) is provided to outlet to control the flow, configuration, rate, or volume of the output mixture.

In some embodiments of the invention, a flow restrictor 416 and/or a check valve 418 are used to control flow of the liquid from/back to the reservoir 410 such as described elsewhere herein with respect to other embodiments. Optionally, a sealing plug 420 is provided to the bypass tube 402.

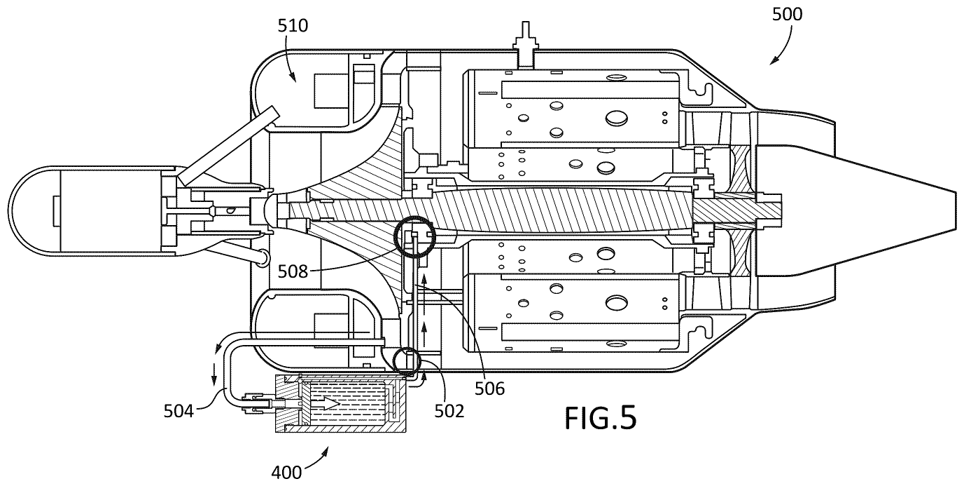

FIG. 5 is a schematic diagram showing the pressure driven fluid delivery system 400 of FIG. 4A being used in conjunction with a simple jet engine 500, in accordance with an exemplary embodiment of the invention. In some embodiments of the invention, compressed air used by the fluid delivery system 400 comes from a feed line to the compressor combustor 502 interface. The bypass air 504 is input into the fluid delivery system 400, for example at the inlet 404, shown in FIG. 4A. Pressure exerted on the liquid reservoir outputs fluid 506 or a liquid and/or gas mixture back into the engine 500 towards an area of application 508. As described elsewhere herein, the output fluid 506 could be lubrication fluids, anti-corrosion fluids, protective fluids, hydrating fluids, thermo-protective fluids and other fluids, depending on the needs of a particular area of application 508 in the engine 500, for example at least one bearing or gear needing a lubricant fluid.

In an embodiment of the invention, the fluid delivery system 400 can be next to the engine 500, incorporated within the engine 500 and/or can be remotely located from the engine 500 (e.g. elsewhere on the vehicle/aircraft/structure). As examples, the fluid delivery system may be contained inside of existing spaces within the engine 500. For example, in the doughnut shaped housing 510. The fluid delivery system may also be contained inside of a:
(i) a static nose cone, in engines that have one; and/or
(ii) a static tail cone, in engines that have one; and/or
(iii) a static strut.

Adaptation to situate the fluid delivery system in empty spaces within the engine (or elsewhere) is particularly advantageous in membrane/bellows driven configurations, where the fluid delivery system exterior and internals do not necessarily need to be cylindrical in shape. This allows them to use existing structures to reduce overall volume and cost, and allow the fluid to be very close to the working zone it is targeting.

In some embodiments of the invention, the systems described herein are purely mechanical. For example, for certain applications once the compressor starts operation, gas/air flow goes directly into the system and gas/liquid mixture starts flowing out of the system.

However, in some embodiments electrical control could be added to these systems, for example adding a solenoid valve that commences gas/air flow from the compressor when opened. Optionally, the solenoid valve is powered by a controller (probably the on-board FADEC). It would then open the valve when instructed by the controller, and flow would begin at that time.

It should be noted that other embodiments of the invention may deliver the fluid (either a gas/liquid mixture or a solid/liquid combination) into a hollow rotating shaft, which delivers the reservoir fluid from the inside of the shaft and outward to the bearings through a hole in the shaft. In such embodiments, they do not necessarily need the bleed air to effectuate fluid output, as the shaft is self-pumping. However, the bleed air may be used, and external ambient air may also be used to carry reservoir fluid to the application area.

FIG. 4B is a cross-sectional view of a fluid pressure driven fluid delivery system 450 with an integrated bypass tube 452, in accordance with an exemplary embodiment of the invention. A notable distinction between the fluid delivery system 450 and fluid delivery system 400 is the presence of more than one input, fluid source A 454 and fluid source B 480. In an embodiment of the invention, fluid from one or both sources can be introduced into the fluid delivery system 450 for direct output from the system through a bypass tube 452 to an application area and/or for exerting pressure against the piston 456 to effectuate the output of fluid in the liquid reservoir 460. In an embodiment of the invention, bypass flow into the tube 452 is controlled by valve (not shown).

Pressure exerted on the piston 456 by the pressurized fluid causes the piston 456 to move 476, expelling liquid in a liquid reservoir 460 downstream 478 towards a mixing chamber 462, where the liquid from the reservoir 460 is optionally mixed with the fluid/gas/air which is introduced into the chamber 462 from the bypass tube 452. The liquid/gas mixture is then output from the system 450 at an outlet 464, in some embodiments of the invention. In some embodiments, a nozzle (not shown) is provided to outlet to control the flow, configuration, rate, or volume of the output mixture.

In some embodiments of the invention, a flow restrictor 466 and/or a check valve 468 are used to control flow of the liquid from/back to the reservoir 460 such as described elsewhere herein with respect to other embodiments. Optionally, a sealing plug 470 is provided to the bypass tube 452.

In some embodiments of the invention, a fluid reservoir system is provided with more than one fluid reservoir. A plurality of reservoirs provides additional functionality, including allowing the use of different fluids, so that one may flow:
a) Before the another (in an application, one fluid type may be desired before the other one)
b) Together, simultaneously with the other fluid. This allows mixing of the fluids, which may be desired, as well as providing a higher likelihood that at least one of the fluids will reach the target when operating under certain conditions.

For example, a secondary reservoir may contain a fluid, less viscous than the fluid in a primary reservoir, which flows more reliably than the fluid of the first reservoir, particularly in cold conditions. Adding the secondary fluid reservoir provides a method for the less viscous fluid to be delivered first, while the first reservoir, for example, heats up and eventually starts flowing.

FIG. 6A is a cross-sectional view of a pressure driven fluid delivery system 600 with a secondary reservoir 630, in accordance with an exemplary embodiment of the invention. In this embodiment, a secondary reservoir 630 is downstream of the first fluid reservoir 610. When the pressurized gas/fluid is activated for input into the system 600, the piston 606 will push 626 the fluid in the first reservoir 610, which will then in turn push and/or empty the secondary reservoir 630 first (i.e. the fluid in the secondary reservoir 630 will be output from the system 600 before fluid from the first reservoir is output). Check valves 616, 618 keep the two fluid reservoirs 610, 630 from mixing when not in use, and/or from emptying out of the pod during storage, for example. Optionally, a flow restrictor 632 is provided to the system 600 upstream from the first check valve 616 and the secondary reservoir 630. Optionally, a flow restrictor 634 is provided to the system 600 upstream from the second check valve 618. The remaining features 604, 612, 614, 620, 622, 624, 628 optionally operate similarly to parallel features described in other embodiments herein, for example FIG. 4A.

FIG. 6B is a cross-sectional view of an alternative pressure driven fluid delivery system 650 with a secondary fluid reservoir 686, in accordance with an exemplary embodiment of the invention. In this embodiment, the secondary liquid reservoir 686 is pushed by fluid flowing through the bypass tube 652, for example coming from an inlet 654. The second reservoir 686 may be configured as shown in FIG. 6B, with the reservoir 686 in the bypass tube 652, or there can be a larger reservoir that holds the secondary fluid. There are also check valves 680, 682 holding the fluid in the secondary reservoir 686 in place, in some embodiments of the invention. There may be a secondary flow restrictor 684 that works on the secondary fluid, upstream from check valve 684, in some embodiments. A difference between system 650 and system 600 is that the fluid from the secondary reservoir 686 of system 650 flows through a different flow restrictor then does the fluid from the first liquid reservoir 660.

The remaining features 656, 658, 662, 664, 668, 670, 672, 674, 676 optionally operate similarly to parallel features described in other embodiments herein, for example FIG. 4A. For example, in some embodiments of the invention, a window 672 is provided to the inlet 654 to allow at least some flow 674 of pressurized fluid to be diverted from the piston 656 to bypass exerting pressure on the piston 656 and instead flow around towards the integrated bypass tube 652. In an embodiment of the invention, bypass flow into the tube 652 is controlled by valve (not shown).

FIG. 7 is a cross-sectional view of a bellows driven fluid delivery system 700 wherein the bellows acts a “piston”, such as the piston embodiments described above, in accordance with an exemplary embodiment of the invention. For brevity, it is noted that many of the features 702, 708, 712, 714, 716, 718, 720, 722, 724 of the bellows driven fluid delivery system 700 operate in a similar fashion as those of the pressure driven fluid delivery system 400 of FIG. 4A, however, instead of using a piston to apply the pressure driving force, a bellows 726 is used. In an embodiment of the invention, a bellows guide 728 is pressed by inlet fluid 704 to cause compression of the bellows 726 and subsequent expulsion of fluid disposed within a membrane 730 which is housed inside the bellows 726. In some embodiments, the membrane 730 is stretched during filling of the reservoir fluid, biasing the membrane 730 with a spring-like force. Additionally, alternatively and/or optionally a spring or springy structure is used to provide a force to the membrane.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The term “plurality” means “two or more”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A pressure driven fluid delivery system, comprising:
at least one source of pressurized fluid; and,
a pod, comprising,
at least one inlet in fluid communication with the at least one source,
a piston in fluid communication with the inlet, wherein pressure exerted on the piston by the pressurized fluid causes the piston to move into at least one reservoir, applying pressure to at least one reservoir fluid disposed therein,
an outlet in fluid communication with the at least one reservoir for output of at least the at least one reservoir fluid being pressured out of the reservoir by the piston,
a pressurized fluid bypass tube in fluid communication with the inlet at one end and in fluid communication with the outlet at a second end, and,
wherein the output at least one reservoir fluid and the bypassed pressurized fluid are combined to form a mixture to be applied at an area of application.

2. The pressure driven fluid delivery system according to claim 1, wherein the at least one reservoir fluid and the bypassed pressurized fluid are combined in a mixture chamber located within the pod.

3. The pressure driven fluid delivery system according to claim 1, further comprising at least one flow regulator or flow restrictor between the at least one source of pressurized fluid and the inlet.

4. The pressure driven fluid delivery system according to claim 1, further comprising at least one flow regulator or flow restrictor between the at least one reservoir and the outlet.

5. The pressure driven fluid delivery system according to claim 1, further comprising at least one check valve between the at least one reservoir and the outlet.

6. The pressure driven fluid delivery system according to claim 1, further comprising at least one flow regulator or flow restrictor between the at least one source of pressurized fluid and the pressurized fluid bypass tube.

7. The pressure driven fluid delivery system according to claim 1, further comprising a filter between the reservoir and the outlet.

8. The pressure driven fluid delivery system according to claim 1, further comprising a fill valve in fluid communication with the reservoir.

9. The pressure driven fluid delivery system according to claim 8, wherein the fill valve is one-way.

10. The pressure driven fluid delivery system according to claim 1, wherein the piston comprises at least one of a membrane and a bellows.

11. The pressure driven fluid delivery system according to claim 1, wherein the pressurized fluid is compressor bleed air.

12. The pressure driven fluid delivery system according to claim 1, wherein the pressurized fluid is a liquid.

13. The pressure driven fluid delivery system according to claim 1, wherein a window is disposed in the inlet to provide fluid communication between the inlet and the fluid bypass tube.

14. The pressure driven fluid delivery system according to claim 1, wherein the at least one reservoir fluid is at least one of a lubrication fluid, an anti-corrosion fluid, a protective fluid, a hydrating fluids, and a thermo-protective fluid.

15. The pressure driven fluid delivery system according to claim 1, wherein a portion of the pressurized fluid bypass tube is narrowed to create a Venturi effect at or near an outlet of the fluid reservoir to create a pulling effect on the piston.

16. A method of using a pressure driven fluid delivery system, comprising:
running a fluid compressor;
inputting at least one pressurized fluid into a pod;
applying at least a portion of the at least one pressurized fluid to a piston, bellows or membrane to exert pressure on at least one reservoir fluid in at least one reservoir;
outputting at least a portion of the at least one reservoir fluid from the reservoir;
bypassing at least a portion of the at least one pressurized fluid from the inlet into a fluid bypass tube;
mixing the output reservoir fluid and the at least one bypassed pressurized fluid to create a mixture;
applying the mixture to an area of application.

17. The method according to claim 16, wherein the mixture is a mixture of air and liquid.

18. The method according to claim 17, wherein the mixture forms a mist.

19. The method according to claim 16, wherein the pressurized fluid is compressor bleed air.

20. The method according to claim 16, wherein at least one of the input pressurized fluid and bypassed pressurized fluid is regulated by a regulator or restrictor.

21. The method according to claim 16, wherein flow of the output reservoir fluid is controlled by at least one of a check valve, a flow regulator, a Venturi effect created by a narrowing in the bypass tube, and a flow restrictor.
